(19) United States
(12) Patent Application Publication
(10) Pub. No.: US 2012/0054656 A1
(43) Pub. Date: Mar. 1, 2012

(54) METHOD, APPARATUS, AND COMPUTER PROGRAM PRODUCT FOR ADAPTING MOVEMENT OF CONTENT SEGMENTS

(75) Inventors: Mikko Antero Nurmi, Tampere (FI); Martin Schüle, Tampere (FI)

(73) Assignee: Nokia Corporation, Espoo (FI)

(21) Appl. No.: 12/871,746

(22) Filed: Aug. 30, 2010

(51) Int. Cl. G06F 3/048

(52) U.S. Cl. 715/769

(57) ABSTRACT

An apparatus may include a data manager configured to manage data segments such as user contacts and communications. The apparatus may further include an importance level determiner configured to determine an importance level for each of the data segments. The importance level may be based on a contextual characteristic, and therefore the apparatus may include a contextual characteristic determiner. Further, the apparatus may include a content segment adaptor configured to adapt content segments relating to the data segments. For example, the content segment adaptor may adapt movement of the content segments to provide for relative movement of a selected content segment relative to remaining content segments. Content segments may include avatars, messages, and contact information in some variations.

### TECHNOLOGICAL FIELD

An example embodiment of the present invention relates generally to adapting movement of displayed content segments and, more particularly, relates to an apparatus, a method and a computer program product configured to adapt movement of the content segments to provide for movement of a selected content segment relating to remaining content segments.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or user contacts, receive services and/or share information, media and other content.

With the proliferation of mobile terminals, communications between users have increased. A user may now send and receive voice communications, video communications, text communications, and/or other forms of communications with a mobile device. Thus, some users may receive a substantial number of communications throughout the course of a day. However, it may be difficult to identify important user contacts, communications, and other data segments due to the potentially large number of data segments stored on or otherwise accessible by the mobile terminal. In this regard, manual review of communications, user contacts, and other data segments for those which are most important to the user may be time consuming and difficult. Thus, use of present systems for accessing user contacts, communications, and other data segments may prove frustrating for users.

### SUMMARY

Accordingly, a method, apparatus and computer program product may address the issues described above by adapting movement of content segments to provide for movement of a selected content segment relative to remaining content segments.

In an example embodiment, an improved apparatus comprises at least one processor and at least one memory including computer program code, the at least one memory and the computer program code configured to, with the processor, cause the apparatus to provide for display of a plurality of content segments comprising a selected content segment and a plurality of remaining content segments, provide for movement of the content segments, and adapt movement of the content segments to provide for movement of the selected content segment relative to the remaining content segments.

In an additional example embodiment a method comprises providing for display of a plurality of content segments comprising a selected content segment and a plurality of remaining content segments, providing for movement of the content segments, and adapting movement of the content segments via a processor to provide for movement of the selected content segment relative to the remaining content segments.

In a further example embodiment a computer program product comprises at least one computer-readable storage medium having computer-executable program code portions stored therein, the computer-executable program code portions comprising program code instructions providing for display of a plurality of content segments comprising a selected content segment and a plurality of remaining content segments, program code instructions providing for movement of the content segments, and program code instructions for adapting movement of the content segments to provide for movement of the selected content segment relative to the remaining content segments.

In a further example embodiment an apparatus comprises means for displaying content segments, means for moving content segments, and means for adapting movement. Means for displaying content segments may provide for display of a plurality of content segments comprising a selected content segment and a plurality of remaining content segments. The means for displaying content segments may comprise a user interface, a data manager, and/or a processor. Means for moving content segments may provide for movement of the content segments and may comprise the user interface, the data manager, and/or the processor. Further, means for adapting movement may adapt movement of the content segments to provide for movement of the selected content segment relative to the remaining content segments. The means for adapting movement may comprise the user interface, the content segment adaptor, and/or the processor.

In some embodiments the apparatuses may be further configured to determine an importance level of a data segment, and select the selected content segment relating to the data segment based on the importance level. The apparatuses may also be configured to provide for panning the content segments. Further, the apparatuses may be configured to provide for display of the selected content segment so as to appear displaced from the remaining content segments. Additionally, the apparatuses may be configured to move the selected content segment at a relatively slower speed than the remaining content segments. Also, the apparatuses may be configured to pause movement of the selected content segment. The apparatuses may be further configured to select a selected color of the selected content segment which differs from a remaining color of the remaining content segments and/or configured to select a shape for the selected content segment which differs from a remaining shape of the remaining content segments. The apparatuses may additionally comprise user interface circuitry configured to facilitate user control of at least some functions of the apparatus through use of a display, and cause at least a portion of a user interface of the apparatus to be displayed on the display to facilitate user control of at least some functions of the apparatus. Similar embodiments of the method and computer program product are also provided. Accordingly, such example embodiments of the present invention may adapt movement of content segments to provide for movement of a selected content segment relative to remaining content segments. Thereby, efficiency in browsing content segments may be improved.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to adapt movement of content segments to provide for movement of a selected content segment relative to remaining content segments according to an example embodiment of the present invention;

FIG. 3 illustrates an embodiment of a mobile terminal employing the apparatus of FIG. 2 to adapt movement of content segments in a contacts application according to an example embodiment of the present invention;

FIG. 4 illustrates the mobile terminal of FIG. 3 while adapting movement of content segments according to an example embodiment of the present invention;

FIG. 5 illustrates an embodiment of a mobile terminal employing the apparatus of FIG. 2 to adapt movement of the content segments in a content application which allows the user to select subsets of the user contacts according to an example embodiment of the present invention;

FIG. 6 illustrates an embodiment of a mobile terminal employing the apparatus of FIG. 2 to adapt movement of content segments in a messaging application according to an example embodiment of the present invention;

FIG. 7 illustrates the mobile terminal of FIG. 5 while adapting movement of content segments according to an example embodiment of the present invention; and

FIG. 8 illustrates a flowchart of the operations performed in adapting movement of content segments to provide for movement of a selected content segment relative to remaining content segments according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

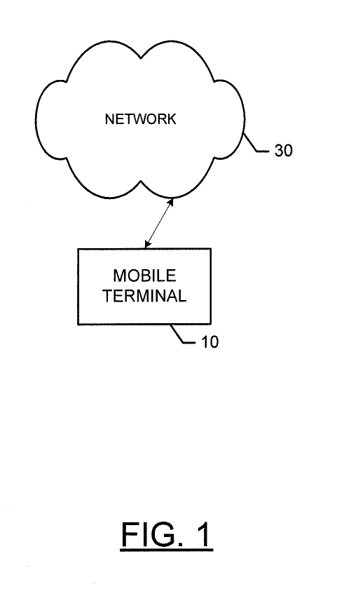

As indicated above, some embodiments of the present invention may be employed in methods, apparatuses and computer program products configured to adapt movement of content segments to provide for movement of a selected content segment relative to the remaining content segments. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a mobile terminal 10. The mobile terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the mobile terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the mobile terminal 10 and the other devices to the network 30, the mobile terminal and/or the other devices may be enabled to communicate with each other, for example, according to numerous communication protocols including Hypertext Transfer Protocol (HTTP) and/or the like, to thereby carry out various communication or other functions of the mobile terminal and the other devices, respectively. As such, the mobile terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

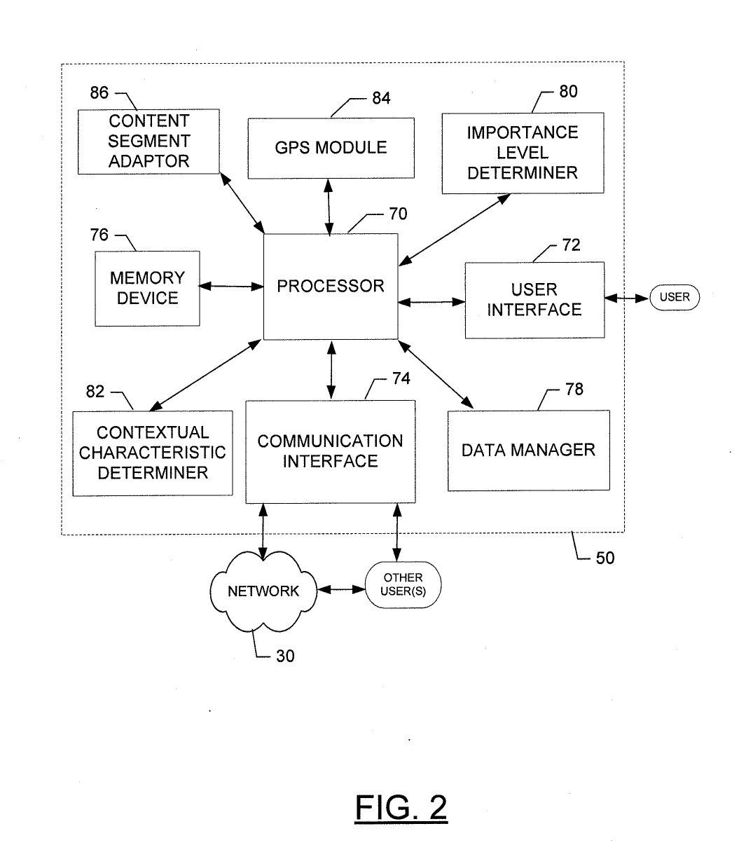

In an example embodiment, an apparatus 50 is provided that may be employed by devices performing example embodiments of the present invention. The apparatus 50 may be embodied, for example, as any device hosting, including, controlling or otherwise comprising the mobile terminal 10. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIG. 2.

With further regard to FIG. 2, the apparatus 50 may be configured to adapt movement of content segments to provide for movement of a selected content segment relative to the remaining content segments. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a mobile terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may further include a data manager 78. The processor 70 or other circuitry may be embodied as, include or otherwise control the data manager 78. The data manager 78 may be configured to manage data segments. Data segments, as used herein, may refer to one or more pieces of stored information. For example, data segments may include user contacts which may be associated, for example, with the apparatus 50 and/or the user. Further, the data manager 78 may be configured to manage data segments relating to communications to and/or from the apparatus 50.

In this regard, the apparatus 50 may store or otherwise have access to a plurality of user contacts for example through use of a contacts application managed by the data manager 78. User contacts may comprise persons, businesses, or other entities for which contact information may be associated therewith. For example, user contacts may have associated therewith contact information such as names, addresses, phone numbers, fax numbers, email addresses, and photos of the user contacts or other avatars. The data manager 78 may manage the user contacts by, for example, allowing a user to upload, create, edit, and/or access the user contacts.

The data manager 78 may further manage communications, as mentioned above. In this regard, the data manager 78 may manage a messaging application, an email application, a phone application, and/or other applications relating to communications. The data manager 78 may manage the communications by, for example, allowing a user to create, edit, access, send, and/or receive communications. Further, the data manager may manage various other types of data segments as may be understood by one having skill in the art. For example, the data segments may include points of interest, videos, music, documents, images, etcetera. Thus, embodiments are discussed herein mainly with respect to data segments comprising user contacts and communications for example purposes only.

In some embodiments the data manager 78 may select one or more content segments relating to one or more of the data segments for adaptation as will be described below. For example, the data manager 78 may select the one or more selected content segments based on an importance level of the data segment. Content segments, as used herein, may include a variety of embodiments of content that the apparatus 50 may output, for example, using the user interface 72. For example, content segments may include displayed content such as messages and user contact information. Thus, while content segments will generally be described herein as relating to communications and user contacts, in various other embodiments the content segments may relate to other types of content which may be represented graphically such as audio and video files, etcetera.

In some embodiments the apparatus 50 may further include an importance level determiner 80. The processor 70 or other circuitry may be embodied as, include or otherwise control the importance level determiner 80. The importance level determiner 80 may be configured to determine an importance level for a user contact, communication or other data segment for which a content segment is associated therewith. In this regard, data segments such as user contacts and communications may be analyzed to determine how important the data segments are to the user. In some embodiments the importance level may be binary. In this regard, the importance level may be either important, or unimportant. However, in other embodiments the importance levels may comprise multiple levels, or a ranked order of importance for each of the data segments. Further, as will be described below, in some embodiments importance levels may change, for example, based on contextual characteristics.

In some embodiments the importance levels for the data segments may be selected by the user. For example, the importance level determiner 80 may ask the user to rank the user contacts based on importance level or ask the user to select an importance level for the user contacts. With regard to communications, the importance level determiner 80 may also allow a user to rank the communications or select an importance level for the communications. In these embodiments determining the importance level of a data segment may comprise receiving a user input comprising the importance level. In other embodiments the important level determiner 80 may determine an importance level of a received communication based on an indicated importance level provided by the sender of the communication. For example, a sender may indicate a communication is of “High Importance,” and the importance level determiner 80 may thereby determine the importance of the communication based thereon.

In other embodiments the importance level determiner 80 may determine the importance levels for the data segments without receiving a user input comprising the importance levels. In this regard, the importance level determiner 80 may employ a variety of techniques and methods to determine the importance levels. For example, the determination of the importance level may be based on communication frequency. By way of example, the importance level determiner 80 may record and analyze how often the user communicates with each of the user contacts through email, instant messaging (IM), short messaging service (SMS), multimedia messaging service (MMS), voice communications, video communications, and/or other communication mediums. The importance level determiner 80 may additionally or alternatively determine the importance levels of the user contacts based on the duration of communications, the length of text-based communications, and/or the data usage associated with exchanging communications with the user contacts. In this regard, frequent and lengthy communications with user contacts may be indicative of high importance levels for the user contacts and the communications. In some embodiments the importance level determiner 80 may weight outgoing communications more heavily than incoming communications in terms of determining importance levels for user contacts. For example, a user may tend to initiate contact with user contacts of higher importance to the user. However, in other embodiments the importance level determiner 80 may equally weight incoming and outgoing communications or weight incoming communications more heavily in determining importance levels of user contacts.

Further, in some embodiments the importance level determiner 80 may alternatively or additionally determine importance levels by determining the relationship between the user and the user contacts and/or the sender of a received message. For example, the user may input contact information that directly describes the user contacts in some embodiments and the importance level determiner 80 may determine the importance levels by reviewing this information. By way of example, the user may classify or otherwise describe the user contacts as relatives, friends, business associates, etcetera. In other embodiments the user may provide greater details with respect to his or her relationship to the user contacts. For example, a contact may be described as the user's father, or boss, etcetera.

However, in some embodiments the importance level determiner 80 may determine the relationship of the user to each of the user contacts and/or senders of received communications without relying on direct user input of this information. For example, the importance level determiner 80 may review communications between the user and the user contacts and/or other entities to which communications are directed or received therefrom. In some embodiments the importance level determiner 80 may review salutations and valedictions appearing in messages. Thereby, for example, if the valediction “Love, Mom” appears in one of the user's communications, the importance level determiner 80 may determine that this user contact and/or communication should have a high importance level.

In other embodiments the importance level determiner 80 may determine the importance level based in part on a received user input and based in part on a calculated importance level that may, for example, be calculated using the above-described methods. For example, the user may directly specify the importance level of some data segments, and the importance level determiner 80 may calculate the importance level for the other data segments. Also, in some embodiments the importance level determiner 80 may allow the user to override a calculated importance level. For example, although a user may receive frequent emails from a user contact that is a business associate, the user contact and the emails may not be important to the user. For example, the emails may relate to daily office roles describing who is out of the office, which may be of little importance to the user. Thereby, the importance level determiner 80 may allow the user to override determined importance levels in some embodiments.

Accordingly, the importance level determiner 80 may employ a variety of techniques and methods to determine the importance levels for the data segments such as by using those embodiments described above as well as various other methods and techniques that are not described herein. Further, in some embodiments the method by which the importance level determiner 80 determines the importance levels may be user selectable. Thereby, for example, the user may select the method or technique that he or she believes may be more likely to most accurately determine the importance level he or she associates with each of the data segments.

Additionally, in some embodiments the importance level determiner 80 may determine the importance level for each data segment based on one or more contextual characteristics of the user and/or the apparatus 50. Thus, the apparatus 50 may further include a contextual characteristic determiner 82, as illustrated in FIG. 2, which is configured to determine a contextual characteristic. The processor 70 or other circuitry may be embodied as, include or otherwise control the contextual characteristic determiner 82.

Contextual characteristics may include the present time, location, activity, etcetera of the user and/or the apparatus 50. Information relating to the location of the user may, for example, be provided by a GPS module 84, though location information may additionally or alternatively be provided through other means such as triangulation using cell phone towers. The processor 70 or other circuitry may be embodied as, include or otherwise control the GPS module 84. Thus, for example, the contextual characteristic determiner 82 may determine that the user is presently near a user contact based on stored user contact information or shared location information or near a location mentioned in a communication. In such instances, the importance level determiner 80 may determine that the user contact and/or the communication has a relatively high importance level at that point in time based on proximity. For example, if the user receives an email from a friend while the user happens to be near the friend, the user may be more inclined to respond to the communication because of the possibility for meeting in person with the friend.

By way of further example, the contextual characteristic determiner 82 may determine when the user is sleeping or working or determine contextual characteristics indicative of these activities and provide this information to the importance level determiner 80. For example, the contextual characteristic determiner 82 may determine that the user is home at night based on time and location information. These contextual characteristics may then be used by the importance level determiner 80 to determine the importance level of the data segments given these contextual characteristics. For example, if in previous circumstances with similar determined contextual characteristics the user has only responded to messages from certain ones or types of the user contacts, then the importance level determiner 80 may determine that those user contacts and corresponding communications have higher importance levels than others. Accordingly, in some embodiments the importance level determiner 80 may determine the importance levels of the data segments based on contextual characteristics, as may be determined by the contextual characteristic determiner 82. Thus, in some embodiments the importance levels may be determined for a variety of contextual characteristics such as user/apparatus location, time of the day, usage history of the apparatus, etcetera. Thereby, the determined importance levels of the data segments may change as the contextual characteristics change in some embodiments.

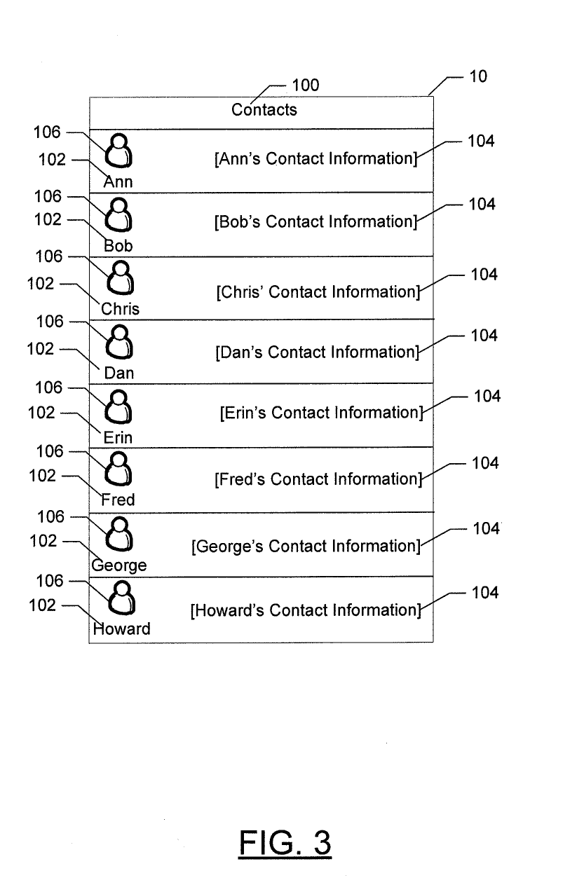

In some embodiments the apparatus 50 may further include a content segment adaptor 86. The processor 70 or other circuitry may be embodied as, include or otherwise control the content segment adaptor 86. The content segment adaptor 86 may be configured to adapt content segments. In this regard, the content segment adaptor 86 may adapt content segments that are displayed, for example, by the user interface 72. Thus, the content segment adaptor 86 may in various embodiments adapt the size or shape of a content segment, the amount or type of displayed information comprising the content segment, the position of the content segment, visual effects such as the color or glow of the content segment, movement of the content segments, etcetera. For example, FIGS. 3-6 illustrate embodiments of the mobile terminal 10 when the apparatus 50 is embodied therein.

FIG. 3 illustrates the mobile terminal 10 when the mobile terminal is running a contacts application 100. The contacts application 100 may display a list of user contacts 102 with associated user contact information 104 and/or associated avatars 106. Each user contact 102 or a portion thereof, such as the avatar 106 or contact information 104 may be considered content segments in this embodiment. The user contact information 106 may include phone numbers and/or other information associated with the user contacts 102. In some embodiments the contacts application 100 may generally position the contacts 102 in an ordered sequence, as illustrated. In this regard, the contact information 104 and the avatars 106 are shown alphabetically positioned in an ordered sequence based on the names of the user contacts 102, although the contacts application 100 may order the user contacts in various other sequences in some embodiments.

The list of user contacts 102 may be moveable in some embodiments. In this regard, the data manager 78 may provide for scrolling, panning, or other movements of the displayed user contacts 102. Thereby, although not all of the user contacts 102 may be displayed at the same time in some embodiments, the data manager 78 may provide for panning, scrolling or other movement of the user contacts to allow the user to find the user contacts that he or she is looking for. Panning, scrolling, and other movements of the user contacts 102 may occur through use of input gestures on a touch screen, scroll wheels, and other input mechanisms in various embodiments of the user interface 72.

In some embodiments the apparatus 50 may provide for various speeds of movement of content segments. For example, the apparatus 50 may provide for a first panning speed and a second, relatively faster panning speed. Thereby the user may be able to sort through the user contacts 102 at various speeds. In some embodiments only the relatively faster movements may invoke the content segment adaptor 86 to adapt the content segments. For example, when panning at the first speed, the content segment adaptor 86 may not adapt the content segments, whereas when panning at the relatively faster second speed, the content segment adaptor may adapt movement or other characteristics of the content segments. Further, in some embodiments the content segment adaptor 86 may adapt the content segments in different manners depending on the speed or direction of movement of the content segments. For example, the content segment adaptor 86 may progressively adapt the content segments to a greater extent as the speed of the movement of the content segments increases in some embodiments. Thereby selected content segments may be more easily identifiable despite the faster movement.

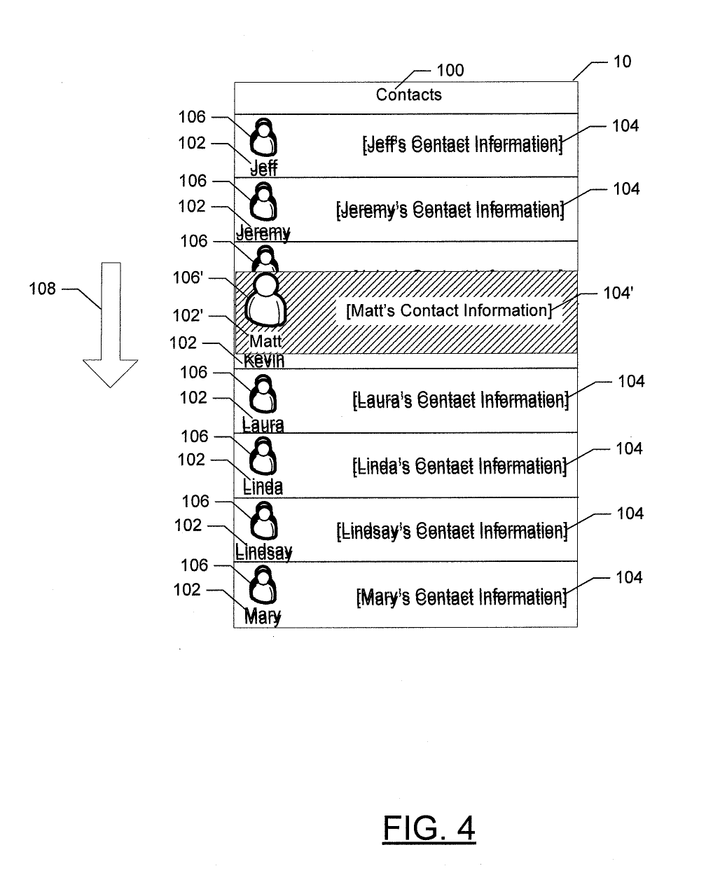

Movement of the contacts 102 in a downward direction 108 is illustrated in FIG. 4. In this regard, the content segments, including the user contacts 102 and associated user contact information 104 and avatars 106, are shown as blurred due to movement. However, the user contact 102′ for Matt and associated contact information 104′ and avatar 106′ are not shown as blurred from movement. In this regard, the user contact 102′ for Matt is the selected content segment in the illustrated embodiment. For example, the importance level determiner 80 may have determined that Matt is the most important of the user contacts 102, and thereby the data manager 78 may have selected one or more content segments related thereto for adaptation. In other embodiments none of the content is blurred, but the user contact 102′ for Matt may remain longer on the screen when scrolling past the place where Matt's contact information is located on the list. In a further embodiment the selected user contact 102 may “jump out” of the remaining user contacts so as to appear closer to the user, for example, when using an autostereoscopic 3-D display.

Thus, the content segment adaptor 86 has adapted movement of the content segments to provide for movement of the selected content segment relative to the remaining content segments. Specifically, the user contact 102′ for Matt is the selected content segment, and the remaining user contacts 102, which comprise the remaining content segments, are moving relative thereto. Thus, the lack of any blur associated with the user content 102′ for Matt illustrates that, by way of example, the content segment adaptor 86 may move the selected content segment at a relatively slower speed, or not at all, relative to the remaining content segments. For example, the content segments may move down the display, and then when the selected content segment is reached, content segment adaptor 86 may adapt the selected content segment so as to be displayed as moving down the display at a slower speed than the remaining content segments. In this regard, the user contact 102′ for Matt, Matt's contact information 104′, and Matt's avatar 106′ may move down the display more slowly than the remaining user contacts 102.

In another embodiment the content segment adaptor 86 may pause movement of the selected content segment relative to the remaining content segments. For example, while panning through the user contacts 102, the content segment adaptor 86 may pause movement of the user contact 102′ for Matt once it reaches a specified section of the display, such as a halfway point. Thereby, the user contact 102′ for Matt, Matt's contact information 104′, and Matt's avatar 106′ may be paused on the display while the remaining user contacts continue moving up or down (or other directions in other embodiments). The content segment adaptor 86 may then cause the user contact 102′ for Matt to fade away, move the user contact 102′ for Matt in the same direction as the remaining user contacts 102 or otherwise stop display of the selected user contact.

Further, in some embodiments the content segment adaptor 86 may adapt movement of content segments to provide for movement of the selected content segment relative to the remaining content segments in a variety of other manners as may be understood by one having skill in the art. For example, the selected content segment may move in or out of view in a direction perpendicular to the direction of movement of the remaining content segments. For example, the user contact 102′ for Matt may move to the right out of the displayed area while the remaining user contacts 102 are moving in the downward direction 108, or vice versa. In other embodiments the selected content segment may initially move slower than the remaining content segments and then speed up when exiting the display so as to appear to “catch up” with the remaining content segments. In a further embodiment the selected content segment may initially move faster than the remaining content segments until the selected content segment reaches a position such as the center of the display, pause for a period of time at this position or move slowly therefrom for a period of time, and then speed up to appear to “catch up” with the remaining content segments. However, the content segment adaptor 86 may provide for various other forms of relative movement between the selected content segment and the remaining content segments in various other embodiments.

In some embodiments the data manager 78 may select more than one selected content segment. Thus, depending on the location of the selected content segments with respect to one another in the sequence, there may be more than one selected content segment displayed at one time. In such instances, the selected content segments may occupy respective portions of the display while the remaining content segments continue moving relative thereto. Further, various levels of importance may be displayed. For example, the selected content segment for the most important data segment may be brought to the front of the user interface and highlighted, while slightly less important data segments may have their associated content segments highlighted slightly less so in the background. Further, various other manners of distinguishing levels of importance may be employed as may be understood by one having skill in the art.

Thus, the content segment adaptor 86 may adapt movement of content segments to provide for movement of the selected content segments relative to the remaining content segments. However, the content segment adaptor 86 may also adapt a variety of other aspects of the content segments. For example, the content segment adaptor 86 may be configured to select a selected color of the selected content segment which differs from a remaining color of the remaining content segments. By way of example with respect to the illustrated embodiment, the content segment adaptor 86 has adapted the user contact 102′ for Matt to have a different color than the remaining user contacts 102. However, the content segment adaptor 86 may select colors and other visual effects for various other portions of the selected content segment to distinguish the selected content segment from the remaining content segments as may be understood by one having skill in the art.

Additionally, in some embodiments the content segment adaptor 86 may adapt the size of the selected content segment relative to the remaining content segments. For example, in the embodiment illustrated in FIG. 4, the user contact 102′ for Matt occupies a greater portion of the screen as compared to each one of the remaining user contacts 102. Thereby, for example, Matt's contact information 104′ may include more information than the contact information 104 for the remaining user contacts 102, and/or Matt's contact information may be displayed in a larger font than the font of the contact information for the remaining user contacts. Further, the avatar 106′ for Matt may be larger than the remaining avatars 106. Accordingly, the content segment adaptor 86 may more prominently display the selected content segment in some embodiments.

Further, in some embodiments the content segment adaptor 86 may adapt the content segments by providing for display of the selected content segment so as to appear displaced from the remaining content segments. For example, the user contact 102′ for Matt is illustrated as being in front of the remaining user contacts 102. Accordingly, in various embodiments the selected content segment may appear in the foreground relative to the remaining content segments, which may thus appear in the background. However, in other embodiments the content segments may be displayed so as to appear displaced in other manners. For example, the content segments may be displayed so as to appear behind the remaining content segments, beside the remaining content segments, etcetera. Additionally, in one embodiment the displacement may be displayed three-dimensionally (i.e. in 3-D) in order to accentuate the displacement of the selected content segment relative to the remaining content segments, for example when the user interface 72 comprises an autostereoscopic 3-D display. Further, in some embodiments the selected content segment may appear partially transparent or translucent so that the remaining content segments may be partially viewable through the selected content segment.

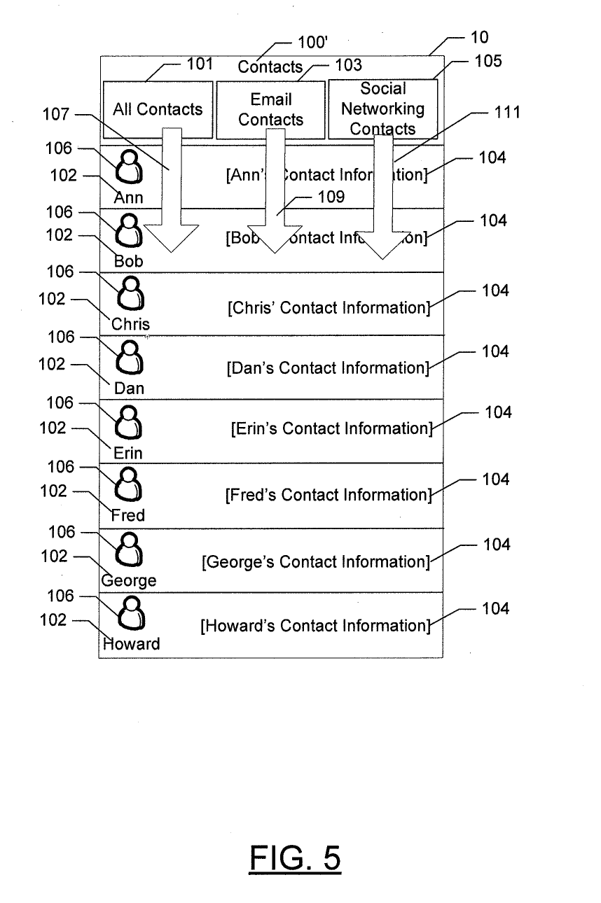

An additional embodiment illustrating adaptation of movement is shown in FIG. 5. As with the previously described contacts application 100, the contacts application 100′ illustrated in FIG. 5 may display a list of user contacts 102 with associated user contact information 104 and/or associated avatars 106. However, the contacts application 100′ may further allow the user to sort the user contacts 102 based on various categories. For example, the user may select an all contacts button 101 which may then cause the display to show all of the user contacts 102. Or the user may select an email contacts button 103 or a social networking contacts button 105 which may then sort the contacts so as to display subsets of the user contacts 102 relating to email contacts and social networking contacts, respectively.

The content segment adaptor 86 may adapt movement of content segments to provide for movement of the selected content segments relative to the remaining content segments as described above with respect to FIGS. 3 and 4. However, additional functionality may be provided in that starting or ending a gesture input 107, 109, 111, such as a swipe on one of the buttons 101, 103, 105, may cause the data manager 78 to select the selected content segment based thereon. For example, when the gesture input 107 starts or ends on the all contacts button 101, all of the user contacts 102 may scroll normally. However, when the gesture input 109, 111 starts or ends on the email contacts button 103 or the social networking button 105, the data manager 78 may select the selected content segment from the subset of the user contacts 102 relating to email contacts or social networking contacts, respectively. Thereby, for example, the entire list of the user contacts 102 may scroll on the screen, but the user contacts relating to the email contacts button or the social networking button, may be highlighted, displaced to the front, or otherwise adapted relative to the remaining user contacts. Thus in this embodiment the point at which the gesture input 107, 109, 111, begins or ends may control the criteria by which the selected content segments are selected. Similar functionality may be provided for other subsets of the user contacts 102. For example, subsets and respective buttons may relate to work contacts, friends, nearby contacts, etcetera.

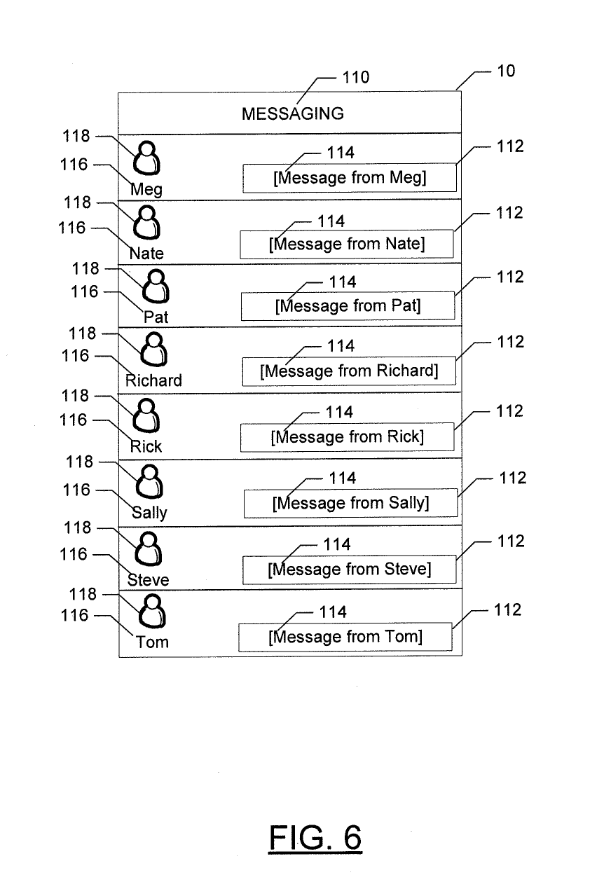

Although the example embodiment described above relates to operation of the apparatus 50 within the context of the contacts application 100, the apparatus may be employed for use in various other applications. For example, FIG. 6 illustrates the mobile terminal 10 employing the apparatus 50 to run a messaging application 110. As illustrated, the messaging application 110 may display a plurality of message boxes 112 which contain messages 114 from a plurality of user contacts 116. The messaging application 110 may also display respective avatars 118 which may assist the user in identifying the user contacts 116 from which the messages 114 originate. Thus, in this embodiment the content segments may comprise one or more of the message boxes 112, messages 114, user contacts 116, and avatars 118.

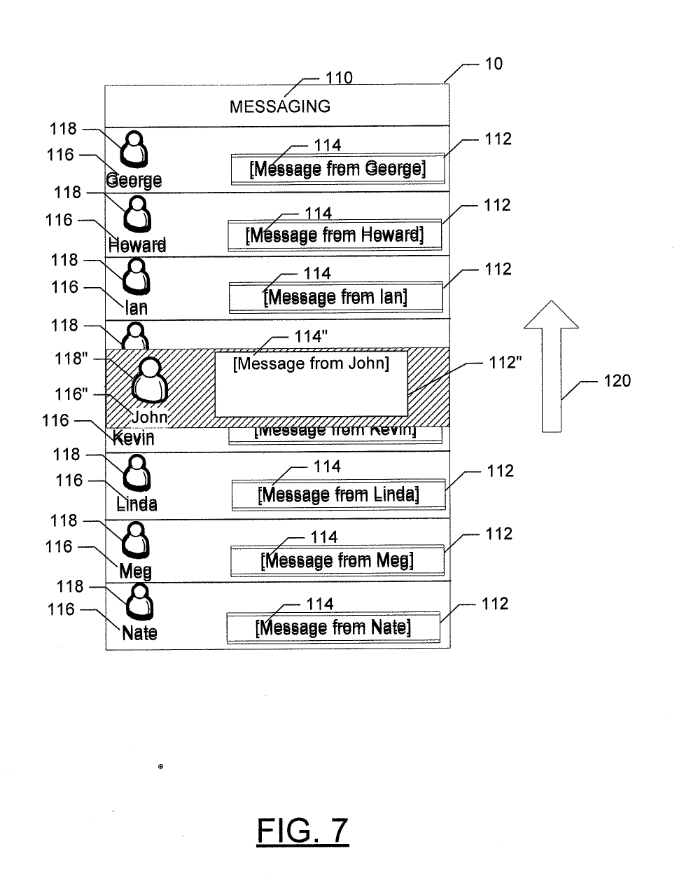

The operation of the content segment adaptor 86 and various other portions of the apparatus 50 as they relate to the messaging application 110 may be substantially similar to that described above with respect to the contacts application 100. Briefly, however, FIG. 7 illustrates the messaging application 110 while the messages 114 are panning in an upward direction 120. A message from John 114″ is illustrated as the selected content segment. For example, the importance level determiner 80 may have determined that the message from John 114″ is the most important message and/or the importance level determiner may have determined that John is the most important user contact 116″.

Thus, as illustrated, the message from John 114″ may be adapted in a manner similar to the manner in which the selected content segments were adapted as described above. For example, the message from John 114″ may be paused or moved at a relatively slower speed than the remaining messages 114, as illustrated by the blur of the remaining messages. Further, the message box 112″, the avatar 118″ and other features relating to the message from John 114″ are illustrated as being relatively larger in size than those features relating to the remaining messages 114. Accordingly, for example, more of the message from John 114″ may be displayed without truncation, and/or the message from John may be displayed in a relatively larger font. Further, the message from John 114″ may be displayed so as to appear in front of the remaining messages 114. Additionally, a selected color associated with the message from John 114″ may differ from a remaining color of the remaining messages 114. Accordingly, in some embodiments the apparatus 50 may be applied to adapt a selected content segment in the context of the messaging application 110 and various other applications.

However, as noted above, various other embodiments of the apparatus 50 may relate to other types of data segments and other functionalities which may be performed by the apparatus. For example, the apparatus 50 may be configured to operate a map application which displays points of interest. For example, the map application may display the location of user contacts and places which may be of interest to the user. In such embodiments the map application may allow the user to scroll across the map, and the points of interest may be adapted, for example, using the methods described above. Thereby, for example, user contacts which are determined to be important may be highlighted as the user scrolls across the map. As may be understood by one having skill in the art, embodiments of the apparatus 50 may be employed in similar manners with other applications operable by the apparatus which allow for scrolling, panning , or other movement of content segments.

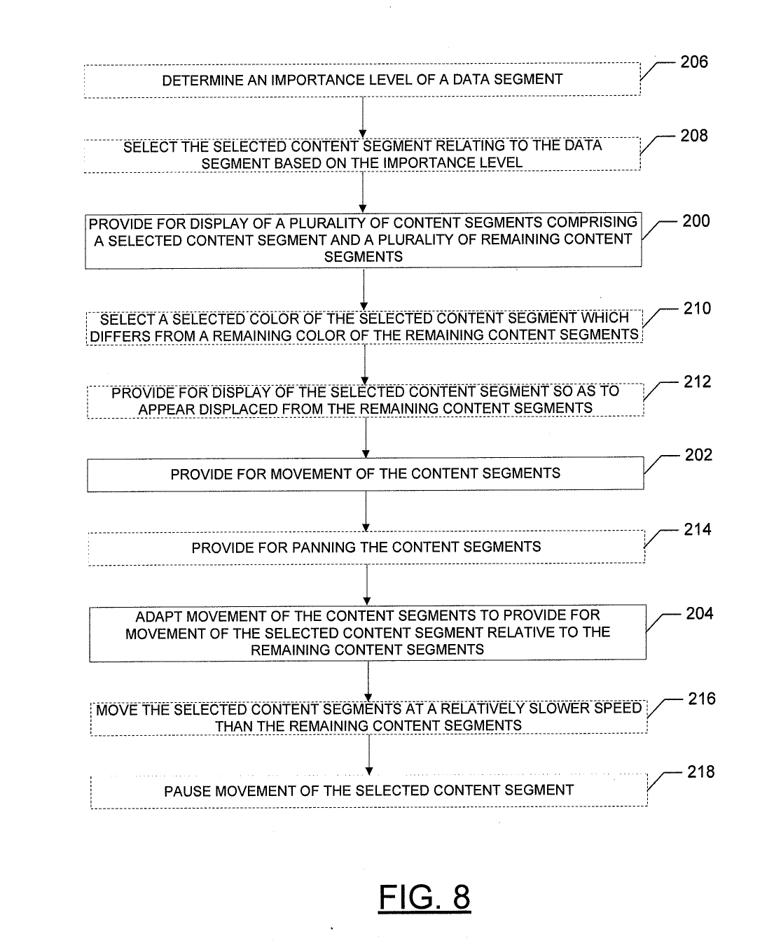

In terms of methods associated with embodiments of the present invention, the above-described apparatus 50 or other embodiments of apparatuses may be employed. In this regard, FIG. 8 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method includes providing for display of a plurality of content segments comprising a selected content segment and a plurality of remaining content segments at operation 200. Further, the method may include providing for movement of the content segments at operation 202. Additionally, the method may include adapting the movement of the content segments to provide for movement of the selected content segment relative to the remaining content segments at operation 204.

In some embodiments, certain ones of the above-described operations (as illustrated in solid lines in FIG. 8) may be modified or further amplified. In some embodiments additional operations may also be included (some examples of which are shown in dashed lines in FIG. 8). It should be appreciated that each of the modifications, optional additions or amplifications may be included with the above-described operations (200-204) either alone or in combination with any others among the features described herein. As such, each of the other operations as will be described herein may be combinable with the above-described operations (200-204) either alone or with one, more than one, or all of the additional operations in any combination.

For example, the method may further comprise determining an importance level of a data segment at operation 206 and selecting the selected content segment relating to the data segment based on the importance level at operation 208. The method may additionally include selecting a selected color of the selected content segment which differs from a remaining color of the remaining content segments at operation 210. The method may further include providing for display of the selected content segment so as to appear displaced from the remaining content segments at operation 212. In some embodiments the content segments may be moved via panning and accordingly the method may comprise providing for panning the content segments at operation 214. Also, the method may comprise moving the selected content segment at a relatively slower speed than the remaining content segments at operation 216. The method may further comprise pausing movement of the selected content segment at operation 218.

In an example embodiment, an apparatus for performing the method of FIG. 8 and other methods described above may comprise a processor (for example, the processor 70) configured to perform some or each of the operations (200-218) described above. The processor may, for example, be configured to perform the operations (200-218) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-218 may comprise, for example, the processor 70, the user interface 72, the communication interface 74, the data manager 78, the importance level determiner 80, the contextual characteristic determiner 82, the GPS module 84, and/or the content segment adaptor 86, as described above. However, the above-described portions of the apparatus 50 as they relate to the operations of the method illustrated in FIGS. 8 are merely examples, and it should be understood that various other embodiments may be possible.

In some embodiments the operation 200 of providing for display of a plurality of content segments comprising a selected content segment and a plurality of remaining content segments may be conducted by means (e.g. means for displaying content segments), such as the user interface 72, the data manager 78, and/or the processor 70. Further, the operation 202 of providing for movement of the content segments may be conducted by means (e.g. means for moving content segments), such as the user interface 72, the data manager 78, and/or the processor 70. Additionally, the operation 204 of adapting movement of the content segments to provide for movement of the selected content segments relative to the remaining content segments may be conducted by means (e.g. means for adapting movement), such as the user interface 72, the content segment adaptor 86, and/or the processor 70.

Also, the operation 206 of determining an importance level of a data segment may be conducted by means, such, as the importance level determiner 80, the contextual characteristic determiner 82, the GPS module 84, and/or the processor 70. Further, the operation 208 of selecting the selected content segment relating to the data segment based on the importance level may be conducted by means, such as the data manager 78, the importance level determiner 80, the contextual characteristic determiner 82, the GPS module 84, and/or the processor 70. Additionally, the operation 210 of selecting a selected color of the selected content segment which differs from a remaining color of the remaining content segments may be conducted by means, such as content segment adaptor 86, and/or the processor 70. Also, the operation 212 of providing for display of the selected content segment so as to appear displaced from the remaining content segments may be conducted by means, such as the user interface 72, the content segment adaptor 86, and/or the processor 70. Further, the operation 214 of providing for panning the content segments may be conducted by means, such as the user interface 72, the data manager 78, and/or the processor 70. Additionally, the operation 216 of moving the selected content segments at a relatively slower speed than the remaining content segments and the operation 218 of pausing movement of the selected content segment may be conducted by means, such as the user interface 72, the data manager 78, the content segment adaptor 86, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
provide for display of a plurality of content segments comprising a selected content segment and a plurality of remaining content segments;
provide for movement of the content segments; and
adapt movement of the content segments to provide for movement of the selected content segment relative to the remaining content segments.

2. The apparatus of claim 1, further configured to:
determine an importance level of a data segment; and
select the selected content segment relating to the data segment based on the importance level.

3. The apparatus of claim 1, further configured to provide for display of the selected content segment so as to appear displaced from the remaining content segments.

4. The apparatus of claim 1, further configured to move the selected content segment at a relatively slower speed than the remaining content segments.

5. The apparatus of claim 1, further configured to pause movement of the selected content segment.

6. The apparatus of claim 1, further configured to select a selected color of the selected content segment which differs from a remaining color of the remaining content segments.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
providing for display of a plurality of content segments comprising a selected content segment and a plurality of remaining content segments;
providing for movement of the content segments; and
adapting movement of the content segments via a processor to provide for movement of the selected content segment relative to the remaining content segments.

9. The method of claim 8, further comprising:
determining an importance level of a data segment; and
selecting the selected content segment relating to the data segment based on the importance level.

10. The method of claim 8, further comprising providing for display of the selected content segment so as to appear displaced from the remaining content segments.

11. The method of claim 8, further comprising moving the selected content segment at a relatively slower speed than the remaining content segments.

12. The method of claim 8, further comprising pausing movement of the selected content segment.

13. The method of claim 8, further comprising selecting a selected color of the selected content segment which differs from a remaining color of the remaining content segments.

14. The method of claim 8, further comprising providing for panning the content segments.

15. A computer program product comprising at least one computer-readable storage medium having computer-executable program code portions stored therein, the computer-executable program code portions comprising:
program code instructions providing for display of a plurality of content segments comprising a selected content segment and a plurality of remaining content segments;
program code instructions providing for movement of the content segments; and
program code instructions for adapting movement of the content segments via a processor to provide for movement of the selected content segment relative to the remaining content segments.

16. The computer program product of claim 15, further comprising:
program code instructions for determining an importance level of a data segment; and
program code instructions for selecting the selected content segment relating to the data segment based on the importance level.

17. The computer program product of claim 15, further comprising program code instructions providing for display of the selected content segment so as to appear displaced from the remaining content segments.

18. The computer program product of claim 15, further comprising program code instructions for moving the selected content segment at a relatively slower speed than the remaining content segments.

19. The computer program product of claim 15, further comprising program code instructions for pausing movement of the selected content segment.

20. The computer program product of claim 15, further comprising:
program code instructions for selecting a selected color of the selected content segment which differs from a remaining color of the remaining content segments.
